(19) United States
(12) Patent Application Publication
(10) Pub. No.: US 2008/0203894 A1
(43) Pub. Date: Aug. 28, 2008

(54) DISPLAY DEVICE

(76) Inventors: Motoyuki Miyata, Hitachinaka (JP); Osamu Shiono, Hitachi (JP); Yuichi Sawai, Miyazaki (JP); Hiroki Yamamoto, Hitachi (JP); Takashi Naito, Funabashi (JP); Keiichi Kanazawa, Ome (JP); Nobuhiko Hosotani, Miyazaki (JP); Hiroshi Ito, Chiba (JP); Akira Hatori, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/018,553

(22) Filed: Jan. 23, 2008

(30) Foreign Application Priority Data
Feb. 23, 2007 (JP) 2007-043131

(51) Int. Cl. H01J 63/04

(52) U.S. Cl. 313/495

(57) ABSTRACT

The purpose of the invention is to improve the mass productivity of display devices by using a glass substrate that prevents the degradation of an electrode caused by glass of the display device. The present invention provides a flat panel display device containing at least two substrates and a light emitting part provided between the two substrates, wherein at least one substrate of the two substrates contains SiO₂ as a main component and contains 1% to 10% by weight of at least one type selected from the group consisting of La, Y, Gd, Yb, and Lu in terms of oxides, 5% to 25% by weight of R₂O (R denotes one or more types selected from a group consisting of Li, K, Cs, and Rb), and 8% to 20% by weight of Al₂O₃, and wherein the surface electric resistance at 350° C. of the glass material is higher than 1×10⁸ (Ω/square).

### FIELD OF THE INVENTION

The present invention relates to a display device and a production method thereof, and in particular is suitable for flat panel display devices having an electron source.

### BACKGROUND OF THE INVENTION

As display devices excellent in high brightness and high definition, liquid crystal display devices, plasma display devices, and the like are put in practical use in place of conventional color cathode ray tubes. Moreover, among others, as those allowing for higher brightness, various types of panel type display devices such as an electron emission type display device, an organic electroluminescence display device characterized in low power dissipation, and the like, are put in practical use or are in preliminary stages for practical use.

Patent documents related to the electron emission type display device include Patent Document 1, Patent Document 2, Patent Document 3, etc. In this type of display device, a back panel in which a plurality of thin film type electron sources are formed in the inner surface of a first glass substrate, and a front panel in which an anode and a fluorescent substance are formed in the inner surface of a second glass substrate, the inner surface of the second glass substrate being opposite to an electron source forming surface of the first glass substrate, are oppositely arranged at a predetermined gap, and the first glass substrate constituting the back panel and the second glass substrate constituting the front panel are bonded together at an outer peripheral inner edge via a sealing frame that is preferably made of glass, thereby constituting an airtight container (also referred to as a vacuum container, in this case)

(Patent Document 1) JP-A-9-283059

(Patent Document 2) JP-A-2000-21335

(Patent Document 3) JP-A-8-22782

### BRIEF SUMMARY OF THE INVENTION

An electron source is formed on a glass substrate. For this reason, sodium that diffused from the glass material by heat treatment during manufacturing process may degrade an electrode of the electron source. Accordingly, a diffusion prevention layer is formed between a panel glass and the electrode. This decreases mass productivity of a product and also increases the cost.

Moreover, a glass substrate used in a display device is also required to have thermal properties, such as heat resistance against heat treatment during manufacturing process and matching of coefficient of thermal expansion with other members, in addition to the electrical characteristics.

An object of the present invention is to improve mass productivity of display devices by using a glass substrate that prevents the degradation of an electrode caused by glass of a display device. Another object of the present invention is to provide a display device that suppresses the degradation of an electron source and thus achieves high reliability and high brightness.

According to an aspect of the present invention for resolving the above-described problems, the present invention provides a flat panel display device comprises a light emitting part provided between two glass substrates (glass panels) constituting the display panel, wherein a glass material having a high electric resistance at high temperature is used in the glass substrate.

That is, the present invention provides a flat panel display device comprising at least two substrates and a light emitting part provided between the two substrates, wherein at least one substrate of the two substrates is composed of a glass material containing SiO₂ as a main component and containing 1% to 10% by weight of at least one type selected from the group consisting of La, Y, Gd, Yb, and Lu in terms of oxides, 5% to 25% by weight of R₂O (R denotes one or more types selected from the group consisting of Li, K, Cs, and Rb), and 8% to 20% by weight of Al₂O₃, and wherein a surface electric resistance at 350° C. of the glass material is higher than 1×10⁸ (Ω/square).

More specifically, the present invention provides a flat panel display device comprising at least two substrates and a light emitting part provided between the two substrates, wherein at least one substrate of the two substrates is composed of a glass material having the composition of 45% to 65% by weight of SiO₂, 0% to 15% by weight of B₂O₃, 8 to 20% by weight of Al₂O₃, 5% to 25% by weight of R₂O (R denotes one or more types selected from the group consisting of Li, K, Cs, and Rb), 0% to 15% by weight of R′O (R′ denotes an alkaline earth metal), and 1% to 10% by weight of Ln₂O₃ (Ln denotes at least one type selected from the group consisting of La, Y, Gd, Yb, and Lu) in terms of oxides, and wherein the surface electric resistance at 350° C. of this glass material is higher than 1×10⁹ (Ω/square).

Other objects, features and advantages of the invention will become apparent from the following description of the embodiments of the invention taken in conjunction with the accompanying drawings.

### BRIEF DESCRIPTION OF THE DRAWINGS

FIG. 1 is an example of the overall structure of a display device.

FIG. 2 is a schematic view of a back panel.

### DESCRIPTION OF REFERENCE NUMERALS

| | |
|---|---|
| SUB | Glass substrate |
| FR | Sealing frame |
| SPC | Spacer |
| LE | Lower electrode |
| UE | Upper electrode |
| BE | Bus electrode |
| IN | Insulating layer |

### DETAILED DESCRIPTION OF THE INVENTION

Hereinafter, the best embodiment of the present invention is described in detail with reference to the accompanying drawings.

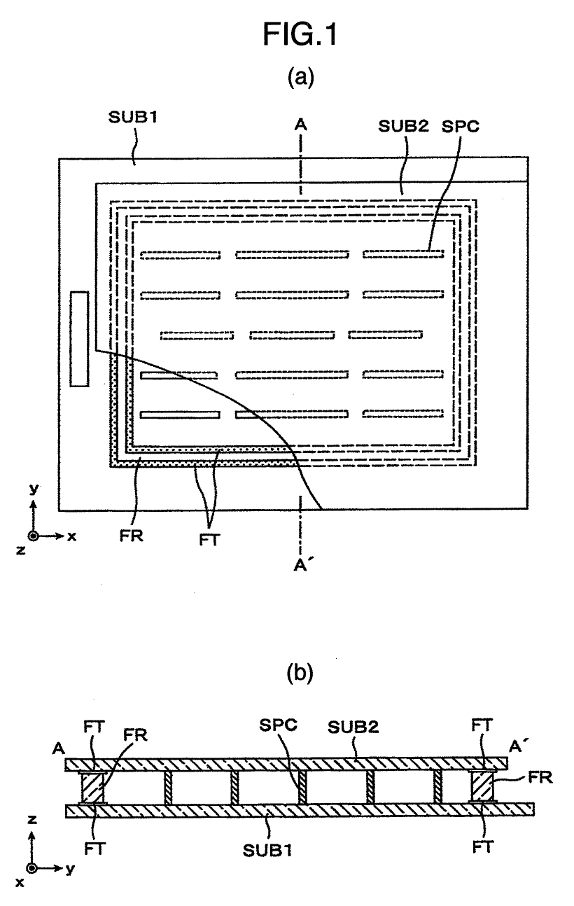

FIG. 1 is a view explaining an example of the overall structure of a display device concerning the present invention. This display device is an electron emission type display device, wherein a back panel, in which a thin film electron source is formed in a first glass substrate SUB1, and a front panel, in which a fluorescent substance and an anode are formed in a second glass substrate SUB2, are integrated via a sealing frame FR to form an airtight container. FIG. 1(a) shows a top view seen from the front panel (first glass substrate) side, and FIG. 1(b) shows a cross sectional view cut along the A-A′ line of FIG. 1(a), respectively.

This display device is constructed with the back panel and the front panel being opposed to each other at a predetermined gap. The back panel comprises the first glass substrate SUB1 in which a number of electron emission sources (negative electrodes, hereinafter, also referred to as cathodes) are formed in the inner surface, while the front panel comprises the light-transmitting second glass substrate SUB2 in which a plurality of colored fluorescent substances and anodes (positive electrodes) are formed in an inner surface opposite to a cathode formation surface of the first glass substrate SUB1, the plurality of colored fluorescent substances and anodes being defined to each other by a black matrix film.

The first glass substrate SUB1 and the second glass substrate SUB2 are oppositely disposed at a predetermined gap via a spacing member (spacer SPC). An adhesive layer (seal frit glass) FT is applied to the inner peripheral edges of the first glass substrate SUB1 and second glass substrate SUB2, and a sealing glass frame FR is interposed therebetween, and these are baked and fixed to form an airtight container. The interior of this airtight container is vacuum pumped through a non-illustrated exhaust pipe. In addition, AR represents the display region.

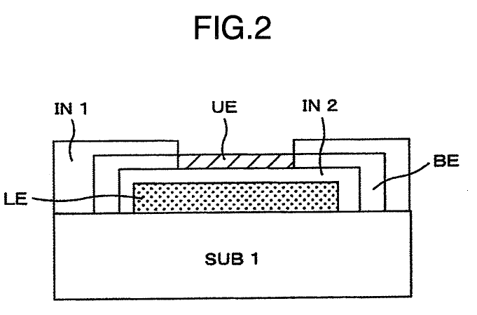

FIG. 2 shows a schematic view of an electrode part of the back panel. In the glass substrate (SUB1), there are formed: a lower electrode that constitutes a signal line (data line) coupled to a signal line driving circuit; an upper electrode (UE) serving as an electron emission electrode; a bus electrode (BE) that constitutes a scanning line coupled to a scanning line driving circuit and is in contact with the upper electrode (UE); an insulating layer (IN2) formed between the lower electrode (LE) and the upper electrode (UE) and the bus electrode (BE); and an insulating layer (IN1) formed above the bus electrode (BE). Al or an aluminum alloy (for example, an Al—Nd alloy or the like) is used in the lower electrode (LE), and a laminated film of Ir, Pt, Au, and the like is used in the upper electrode (UE), but not limited these materials. As the insulating layer (IN2), an oxide formed by oxidizing the lower electrode (LE) (for example, Al₂O₃ or the like) is used. As the bus electrode, an Al—Nd alloy, W, or the like is used. In the insulating layer (IN1), glasses, such as SiO, SiO₂, phosphorus silica glass, or a borosilicated glass, or Si₃N₄, Al₂O₃, polyimide, or the like can be formed.

Due to heat treatment during panel manufacturing process, an alkali metal component, particularly an Na component, contained in the glass substrate (SUB1) diffuses into the lower electrode (LE) and/or the bus electrode (BE) to produce an electrical insulator, thereby decreasing the electric conductivity of the lower electrode (LE) and/or the bus electrode (BE) and thus decreasing the efficiency of electron emission characteristic.

Since the glass material of the present invention substantially does not contain an Na component, the diffusion of Na due to heat treatment and the characteristic degradation of an electron emission source associated therewith can be suppressed.

A glass material according to the present invention will now be described. A large size glass substrate used for an actual image display devices is made, for example, by a float process or the like. A method of making a prototype of a glass material for evaluating various properties of the glass material will be described below.

### (Prototyping of Glass Material)

A predetermined amount of raw material powder was weighed into a platinum crucible, mixed and melted in an electric furnace at 1600° C. to 1700° C. After the raw material is sufficiently melted, a platinum stirring blade was inserted into the glass melt to stir the same for about 40 minutes. After the stirring blade was removed, the glass melt was left at rest for 20 minutes and then poured into a graphite container heated to approximately 400° C. to be rapidly cooled, thereby forming a glass block. Then, the block was reheated to the vicinity of the glass transition temperature of each glass followed by slow cooling at a cooling speed of 1° C. to 2° C./minute to relieve internal stress.

### (Glass Composition)

The component of a glass material of the present invention is as follows. The glass material contains SiO₂ as a main component and contains at least one type selected from the group consisting of La, Sc, Y, Ce, Pr, Nd, Pm, Sm, Eu, Gd, Tb, Dy, Ho, Er, Tm, Yb, and Lu.

The proportion of each of the above-described components is shown in (1) or (2) below.

(1) In terms of oxides, 45% to 65% by weight of SiO₂, 0% to 15% by weight of B₂O₃, 8% to 20% by weight of Al₂O₃, 5% to 25% by weight of R₂O (R denotes one or more types selected from the group consisting of Li, K, Cs, and Rb), 0% to 15% by weight of R′O (R′ denotes an alkaline earth metal), and 1% to 10% by weight of Ln₂O₃ (Ln denotes at least one type selected from the group consisting of La, Y, Gd, Yb, and Lu).

(2) In terms of oxides, 50% to 65% by weight of SiO₂, 0% to 10% by weight of B₂O₃, 10% to 20% by weight of Al₂O₃, 10% to 20% by weight of R₂O (R denotes one or more types selected from the group consisting of Li, K, Cs, and Rb), 5% to 15% by weight of R′O (R′ denotes an alkaline earth metal), 1% to 10% by weight of Ln₂O₃ (Ln denotes at least one type selected from the group consisting of La, Y, Gd, Yb, and Lu).

A coloring component may be added into the glass material of the present invention described above. Use of a glass containing a coloring component can enhance the contrast of a display image without using a colored filter that is conventionally formed in the front face of glass. Hereinafter, each component will be described.

### (1) SiO₂

An SiO₂ content of less than 45% by weight was not preferable since it reduced the mechanical strength and chemical stability. An SiO₂ content of more than 60% by weight reduced the melting property to cause much striae. From these facts, the SiO₂ content is preferably 45% to 65% by weight, and more preferably 50% to 65% by weight.

### (2) B₂O₃

Although boron oxide serves to reduce the high temperature viscosity of a glass for improvement of meltabilty as well as increase the electric resistance, excessive addition causes degradation of the heat resistant temperature or the coefficient of thermal expansion of a glass. When B₂O₃ was contained in the glass material, the resulting glass had excellent melt fluidity and high temperature electric resistance. However, a content thereof exceeding 15% by weight reduced the coefficient of thermal expansion. Thus, the B₂O₃ content is preferably 15% by weight or less, and more preferably 10% by weight or less.

### (3) Alkali Metal Oxide

Alkali metals act as a factor that greatly affects the electrical characteristics of a glass, the thermal properties, such as heat resistant temperature and coefficient of thermal expansion. In particular, Na serves to reduce the electric resistance of a glass material.

Since a glass material according to the present invention substantially does not contain Na among alkali metals, it can prevent the degradation and short circuit of an electron source or an electrode associated with diffusion of Na ions.

Alkali metals except Na include Li, K, Cs, Rb, and etc. A glass according to the present invention contains at least one or more types selected from a group of these.

When the sum of the content of alkali metal oxides (Li₂O, K₂O, Cs₂O, and Rb₂O) represented by R₂O (R denotes an alkali metal) exceeded 25% by weight, chemical stability reduced. However, addition of alkali metal oxides acts to increase the coefficient of thermal expansion of glass materials. Therefore, the sum of the content of alkali metal oxides is preferably 5% by weight or more. For this reason, the sum of the content of alkali metal oxides is preferably from 5% to 25% by weight, more preferably from 10% to 20% by weight.

### (4) Alkaline Earth Oxide

Although an alkali earth metal oxide is effective in improvement in heat resistant temperature of a glass, increase in the coefficient of thermal expansion, improvement in the meltabilty, and the like, excessive addition leads to degradation of mechanical properties.

Although an alkali earth metal oxide represented by R′O (R′ denotes an alkaline earth metal) also acts to increase the coefficient of thermal expansion of glass materials similar to alkali metal oxides, the sum of the additive amount exceeding 15% by weight reduced the mechanical properties. For this reason, the content of alkali earth metal oxides is preferably 15% by weight or less, more preferably from 5% to 15% by weight.

Moreover, alkali metal oxides and alkali earth metal oxides showed similar effect in terms of reducing melting point of glass. However, when the sum of the content thereof is less than 5% by weight, the flowability was poor and numbers of striae appeared. Further, when it exceeds 40% by weight, chemical stability reduced. Consequently, the sum of the content of alkali metal oxides and alkali earth metal oxides is preferably from 5% by weight to less than 40% by weight.

### (5) Al₂O₃

Al₂O₃ was effective in increasing mechanical strength and chemical stability of glass. The effect was remarkable when the content of Al₂O₃ was 8% by weight or more. However, the content exceeding 20% by weight undesirably reduced the flowability of glass. Consequently, the content of Al₂O₃ is preferably from 8% to 20% by weight, more preferably from 10 to 20% by weight.

### (6) Rare Earth Oxide

When the content of a rare earth oxide exceeds 10% by weight, the glass material devitrified and mechanical properties dropped due to formation of insolubles or lack of homogeneity in glass. These phenomena are not preferable. Moreover, when the content is less than 1% by weight, the effect in improving mechanical strength was small. Consequently, the content of a rare earth oxide is preferably from 1% to 10% by weight.

### (7) Others (ZnO, ZrO₂)

Furthermore, ZnO, ZrO₂ and the like other than the above-described oxides can be added. Addition of ZnO is effective in facilitating melting of glass and improving durability of glass. In particular, when the content is 0.5% by weight or more, the effect is desirably more remarkable. However, when the content exceeds 10% by weight, the devitrification of glass is increased and a glass with high homogeneity cannot be obtained.

Addition of ZrO₂ is effective in improving durability of glass. In particular, when the content ranges from 0.5% to 5% by weight, the effect is desirably more remarkable. However, when the content exceeds 5% by weight, the melting of glass becomes difficult and the devitrification of glass is increased.

### (Evaluation of Prototypes of Glass Material)

Electric resistance was measured in accordance with JIS C2141. The micro Vickers hardness (Hv) was measured at 10 points under the conditions of an applied load of 500 g and a loading time of 15 seconds, and the average was used. The measurement was made 20 minutes after the load was applied. The test specimen was 4 mm×4 mm×15 mm in size. The rate of crack occurrence was measured under the same conditions as in the measurement of the micro Vickers hardness except the applied load. The measurement was made within 30 seconds after the load was applied.

### (Properties of Glass)

### (1) Electrical Characteristics (High Temperature Resistance)

A glass material according to the present invention substantially does not contain an Na component. This makes it possible to prevent diffusion of Na in the heat treatment step or the like during production, thus allowing high electric resistance as an electrical characteristic to be kept. On the other hand, since the conventional glass material used for a plasma display device or the like contains up to approximately 5% by weight of the Na component in terms of oxides, the Na component diffuses into the lower electrode (LE) and/or the bus electrode (BE) due to heat treatment during manufacturing process, thereby producing an electrical insulator and causing degradation of the electron emission characteristic. It has been found that in the case of glass material having electric resistance exceeding 10⁸ (Ω/square) at 350° C., the degradation of an electrode due to heat treatment during manufacturing process does not occur and thus does not adversely affect the electron emission characteristic. For this reason, electric resistance of glass material at high temperature is preferably higher than 10⁸ (Ω/square) at 350° C., and more preferably higher than 10⁹ (Ω/square)

### (2) Rate of Crack Occurrence

It shows that the glass materials used in the current CRT and PDP have a crack occurrence rate of 100% at an applied load of 50 g, while the glass material according to the present invention has a crack occurrence rate of approximately 50% at an applied load of 1000 g, thus exhibiting extremely higher resistance to cracking as compared with the current CRT and PDP. The glass material used in the current LCD shows a crack occurrence rate of 50% at an applied load of 500 g, which is more favorable than the glass material for the PDP but is somewhat poorer than the glass material of the present invention.

The glass material according to the present invention has substantially the same coefficient of thermal expansion as the glass material of the current CRT and PDP and shows an extremely higher value of a “load at which the crack occurrence rate is 50%” as compared with the glass material for the current CRT and PDP. The glass material for the LCD, which showed more favorable crack characteristic than the glass material for the current CRT and PDP, has a coefficient of thermal expansion equal to or less than 50×10⁻⁷/° C., which is smaller than that of the PDP or FED and does not satisfy the thermal expansion characteristic required in the glass material for the flat panel display.

### (3) Density

In a display panel and a flat panel display device according to the present invention, the thickness of the glass substrate can be reduced, and thereby the weight of a glass material, in turn the weight of a display panel and a flat panel display device, can be reduced. On the other hand, if the density of a glass material becomes higher, the effect in the weight reduction due to the reduction in the thickness of a glass substrate will be reduced. Therefore, a glass material preferably has a density of 2.7 g/cm³ or less, more preferably 2.6 g/cm³ or less.

### (4) Heat Resistant Temperature (Transition Point)

A glass material according to the present invention preferably has a transition point equal to or greater than 450° C., more preferably equal to or greater than 600° C. This is due to the following reason. In the production process of a display panel, the display panel is subjected to heat treatment in which it is heated to elevated temperatures, in steps such as a joining step and a vacuum pumping step. If the transition point of a glass material is lower than the maximum temperature in the heat treatment step that is actually adopted or assumed in processes for producing various display panels, residual stress may be generated in a glass substrate, thus leading to deficiency or breakage of a display panel.

### (5) Coefficient of Thermal Expansion

A glass material according to the present invention preferably has a coefficient of thermal expansion from 70×10⁻⁷ to 110×10⁻⁷/° C., more preferably from 80×10⁻⁷ to 90×10⁻⁷/° C. in relation to the coefficient of thermal expansion of other members such as a sealing glass material. This is because a coefficient of thermal expansion that is larger or smaller than the above-described values will produce residual stress in the vicinity of a joining part due to the difference in the coefficients of thermal expansion to cause a failure or breakage of the panel.

(6) Young's modulus and specific Young's modulus

A glass material according to the present invention preferably has a Young's modulus equal to or greater than 70 GPa/(g/cm³), and has a specific Young's modulus (a value obtained by dividing Young's modulus by density) equal to or greater than 25 GPa/(g/cm³). This is because if values of Young's modulus and specific Young's modulus are smaller than the above-described values, deformation of a glass substrate may be larger than the current material, thus leading to the deterioration in handling ability which in turn may cause problems in production steps and the deterioration of yield.

### (7) Water Resistance

For water resistance, there is no amount of elution of Na that adversely affects an electron emission source like a chemically toughened glass since a glass material of the present invention substantially does not contain Na. Similarly, also in the heat resistance test, a high amount of Na elements that adversely affect the electron emission source were detected in the surface layer of the chemically toughened glass, while these elements were not detected in the glass material of the present invention.

As described above, Na elements that adversely affect the electron emission source easily move in the chemically toughened glass substrate, thus showing instability of glass. On the other hand, the glass substrate according to the present invention showed good thermal and chemical stability.

### (8) Surface Roughness

Next, as for surface roughness, the glass material according to the present invention showed a good smoothness of an Ra of 0.1 nm to 0.3 nm. The surface roughness after the water resistance test also showed a high smoothness of an Ra of 0.2 nm to 0.4 nm. On the other hand, the chemically toughened glass showed an Ra of 0.9 nm, and showed a larger value of an Ra of 1.5 nm after the water resistance test. Moreover, the glass material according to the present invention showed better results than the glass material that contains no rare earth oxide. As described above, the glass material according to the present invention is excellent in chemical stability, so when a transparent conductive film and an antireflection film are formed on the glass material, these films are excellent in stability with time.

### (Effect of Surface Treatment)

In the glass material of the present invention, the end face on the outer edge and the chamfered surface are preferably etched with hydrofluoric acid, fluoro-nitric acid, fluoro-sulfuric acid, buffered hydrofluoric acid, or the like in order to remove small flaws due to the processing. This treatment can improve a bending strength by at least approximately 30%. In particular, when the etching is performed on the glass that contains the rare earth oxide as the glass component, a significantly high strength can be realized.

(Comparison with Surface Strengthened Glass)

A glass material according to the present invention secures a strength sufficient as the glass substrate. Thus, it does not require surface strengthening treatment such as chemical strengthening treatment that is a conventional strengthening method for glass materials. In other words, the glass material according to the present invention is characterized in that the glass surface has no compressive strengthening layer in which residual stress is generated. The presence or absence of the compressive strengthening layer in the surface can be measured, for example, by a method in which the surface is irradiated with a laser beam and the reflected light is separated with a prism. The measurement of the glass material of the present invention with the above-described method revealed almost no difference between the residual stress in the inside of the glass and that in the surface thereof, that is, there was no surface stress layer.

A glass material according to the present invention is characterized in that there is no compressive strengthening layer in the surface thereof and a stress distribution inside the glass is substantially uniform. As a result, even when the surface of the glass of the present invention has a flaw that has a depth comparable to that of a chemically toughened glass, the whole of the inventive glass will not break into pieces like unlike the chemically toughened glass.

Since the chemically toughened glass has the compressive strengthening layer on the surface and a tensile layer inside for balancing, the thickness is disadvantageously limited depending on a predetermined strength that should be provided. In contrast, the glass material according to the present invention does not need the surface stress layer, so that no limitation is applied on the thickness unlike the chemically toughened glass, thus allowing a thinner glass to be formed. The conventional glass substrate requires a thickness of approximately 2.8 mm to ensure the mechanical strength, while the glass according to the present invention can be used to form a thinner glass substrate than the conventional glass material since the glass material of the present invention is strengthened without performing special strengthening treatment, thereby enabling a reduction in thickness and weight of the flat panel display.

### (Composition of Glass Substrate)

### (1) Thickness of Glass Substrate

In the present invention, the reduction in thickness and weight of a flat panel display device can be expected, because the thickness of a glass substrate can be made thinner than that of the current materials without significantly changing the density of a glass material as compared with that of the conventional glass substrate materials. Moreover, a reduction in time, labor, and cost for carrying and installing a flat panel display device can be expected by reducing the weight of the display. Furthermore, the flat panel display device can be directly installed on a wall or the like.

In particular, in the case of a current plasma display device, the proportion of a glass material in the weight of a monitor (image displaying part) is approximately 35%. A reduction in the thickness of a glass substrate allows the above proportion to be reduced as well as allows the weight of the plasma display device to be reduced.

The weight of glass substrates (two pieces) can be reduced by approximately 30% of the current weight by using a thinner glass substrate thickness of 2.0 mm, and can be further significantly reduced by 46% of the current weight by using a thinner thickness of 1.5 mm. Therefore, a glass substrate preferably has a thickness of 2.0 mm or less, more preferably 1.5 mm or less.

### (2) Front Filter

A glass material according to the present invention can be made as a glass with a small thickness per piece because of a special toughing mechanism. Therefore, when it is particularly used for applications requiring strength, it is possible to further increase strength by laminating two or more sheets of glass via a resin film. The reliability of a flat panel display device can be further improved by using such a laminate glass as a front filter. However, since the total weight of glass materials increases in proportion to the number of laminated glasses, the total thickness of the laminated glass materials is desirably the same or less as that of a one-piece material so that the laminate does not have excessive weight.

Further, in the case of this laminated glass material, it is possible to further increase strength by placing a wire of metal, ceramics, carbon fibers, glass fibers or the like, in a resin layer, when glass lamination is performed.

Furthermore, a wire of metal, ceramics or the like may also be placed in a glass, as a method for placing a wire in the above-described glass material. In this case, a wired glass plate can be made by inserting a wire of heat resistant metal, ceramics or the like while a glass raw material is in a molten state at a high temperature followed by cooling and solidification of the glass raw material. Prevention of falling and scattering of broken glass pieces due to collision of heavy objects can be expected by placing a wire in the above-described transparent glass. This is particularly suitable for a flat panel display device to be installed in the outdoors.

A glass material according to the present invention can be colored by containing various elements. Coloring elements include iron, cobalt, nickel, chromium, manganese, vanadium, selenium, copper, gold, silver, and etc., in addition to rare earth elements. It is possible to improve contrast of a flat panel display device by coloring a glass material by adding a suitable amount of any of these coloring elements depending on applications.

In the case of a structure without a front filter, a layer for adjusting electrical characteristics and a layer for adjusting optical properties as well as a layer for preventing scattering of glass due to breakage in preparation for possible breakage of a glass substrate are formed in a front plate of the display panel. When these layers are formed on the surface of the inventive glass material, advantageously separation, performance degradation, and the like of these layers will not easily occur, since as described above the glass material according to the present invention does not contain Na that is especially movable among the alkali components.

### (3) Long-Term Weatherability

Next, resistance to high temperature and humidity was tested for simulating long-term weatherability of a glass substrate. A glass material of the present invention and a conventional chemically toughened glass material as a comparative example were placed under an environment of a temperature of 85° C. and a humidity of 85% for observing the possible change thereof. The chemically toughened glass of the comparative example showed surface whitening at a time point of 500 hours after starting the test, but this inventive material did not show any particular change.

It is considered that alkali elements in glass material move to the glass surface due to environmental humidity and the like and is precipitated to form surface whitening. If the whitening occurs in the glass material that constitutes the glass substrate on the display side, it will cause quality deterioration of images to be displayed. Since alkali elements in glass easily move to a glass surface in a chemically toughened glass, the whitening will easily occur. On the other hand, since the glass material according to the present invention does not contain an Na component that moves most easily among alkali elements in the glass material, the whitening will not occur easily. Thus, high weatherability of the glass material of the present invention can be expected.

When a display device is installed in the outdoors, contaminants will naturally adhere to the surface thereof by leaving the display to stand for a long period of time. As a result, there is apprehension that the performance of image display deteriorates. Formation of a photocatalyst layer on the surface of a glass allows the cleanness of the surface to be easily maintained because the contamination that adhered to the glass surface is decomposed by light energy, together with the cleaning effect at the time of rainfall. As a result, the deterioration of the performance of the image display can be suppressed.

When a conventional chemically toughened glass is used for the formation of a photocatalyst layer, the photocatalyst layer is apt to be separated from the surface of the glass due to the movement of alkali elements from inside the glass material. On the other hand, when the inventive glass is used, the amount of alkali elution can be reduced significantly as compared with chemically toughened glass material, since the glass material of the present invention does not contain an Na component that moves most easily among alkali elements in the glass material. Consequently, the photocatalyst layer on the inventive glass is hard to be separated and can be easily maintained for a long period of time that is five times or more longer than in the case of a chemically toughened glass.

### EXAMPLES

For the components shown in Table 1, preparation and evaluation of glass materials were performed. Table 1 shows the properties of each glass, as well.

TABLE 1

| | | | | Comparative | Comparative | Comparative | Comparative | Comparative |
|---|---|---|---|---|---|---|---|---|
| | | Example 1 | Example 2 | Example 1 | Example 2 | Example 3 | Example 4 | Example 5 |
| Composition | SiO₂ | 55 | 53 | 60 | 63 | 60 | 60 | 54 |
| (wt %) | B₂O₃ | 8 | — | — | — | — | 8 | 8 |
| | Al₂O3 | 15 | 15 | 7 | 3 | 10 | 15 | 15 |
| | Na₂O | — | — | 4 | 2 | — | 7.5 | — |
| | Li₂O | — | — | — | — | — | 4.5 | 1 |
| | K₂O | 19 | 15 | 6 | 10 | 10 | 2 | 19 |
| | Cs₂O | — | — | — | — | — | — | — |
| | Rb₂O | — | — | — | — | — | — | — |
| | MgO | — | 4 | 2 | 7 | 2 | — | — |
| | CaO | — | 2 | 4.5 | 4 | 2 | — | — |
| | SrO | — | 2 | 7 | 11 | 4 | — | — |
| | BaO | — | 3 | 7 | 0 | 6 | — | — |
| | ZrO₂ | — | — | 2.5 | — | — | — | — |
| | Ln₂O₃ | 3 | 6 | — | — | 6 | 3 | 3 |

| | | | | | | | |
|---|---|---|---|---|---|---|---|
| transition point | 655 | 760 | 630 | 635 | 720 | 503 | 570 |
| (° C.) | | | | | | | |
| α (×10⁻⁷/° C.) | 84 | 82 | 83 | 84 | 76 | 80 | 87 |
| density (g/cm³) | 2.5 | 2.66 | 2.78 | 2.68 | 2.76 | 2.48 | 2.49 |
| Young's modulus | 85 | 83 | 78 | 75 | 80 | 82 | 83 |
| (GPa) | | | | | | | |
| thickness (mm) | 1.8 | 1.8 | 2.8 | 2.8 | 2.8 | 2.8 | 2.8 |
| “load at which the | 20000 | 5000 | 500 | 700 | 1000 | 20000 | 20000 |
| crack occurrence | | | | | | | |
| rate is 50%” (mN) | | | | | | | |

The transition point is a characteristic for evaluating the heat resistance of a glass substrate. The transition point that does not satisfy a predetermined value may cause deformation, cracking, or the like of a glass substrate in the heat treatment step. The transition point of the glass material of the present invention is preferably equal to or higher than 600° C., more preferably equal to or higher than 650° C. This is due to the following reason. The display panel is subjected to heat treatment that involves heating to a high temperature in a joining step and a vacuum pumping step during the process of manufacturing a display panel. If the transition point of the glass material is lower than the highest temperature in the heat treatment step performed or assumed during the process of manufacturing the display panel, residual stress will occur in the glass substrate to cause a failure or breakage of the display panel.

The coefficient of thermal expansion is a characteristic for evaluating a difference in dimensional changes associated with heat treatment between other constituting members, such as a spacer and frit, which form the display device. The coefficient of thermal expansion that does not fall within a predetermined range may cause deformation, cracking, or the like of the constituting members in the heat treatment step. A glass material according to the present invention preferably has a coefficient of thermal expansion of 75×10⁻⁷ to 110×10⁻⁷/° C., more preferably 80×10⁻⁷ to 90×10⁻⁷/° C. in relation to the coefficient of thermal expansion of other members such as a sealing glass material. This is because a coefficient of thermal expansion that is larger or smaller than the above-described values will produce residual stress in the vicinity of a joining part due to the difference in the coefficients of thermal expansion to cause a failure or breakage of the panel.

Young's modulus is a characteristic indicating the deformation of a glass substrate when a predetermined load acts on a glass substrate. The value equal to or less than a predetermined value will produce a large deformation in a glass substrate, thus causing degradation of image display performance or cracking of the glass substrate due to a positional deviation between an electron source and a fluorescent substance. A glass material according to the present invention preferably has a Young's modulus equal to or greater than 70 GPa/(g/cm³), and has a specific Young's modulus (a value obtained by dividing Young's modulus by density) equal to or greater than 25 GPa/(g/cm³). This is because if values of Young's modulus and specific Young's modulus are smaller than the above-described values, deformation of a glass substrate may be larger than the current material, thus leading to the deterioration in handling ability which in turn may cause problems in production steps and the deterioration of yield.

The “load at which the crack occurrence rate is 50%” is a characteristic indicative of the “unflawability” of a glass substrate. Higher value of the “unflawability” indicates that a glass substrate is less likely to be flawed and is less likely to be broken. In the present invention, the load at which the crack occurrence rate is 50% is preferably equal to or greater than 5000 mN. Since the inventive glass substrate is less likely to crack as compared with the conventional glass substrate, the thickness of the inventive glass substrate can be made thinner than that of the current material. Thus, reduction in thickness and weight of a flat panel display device can be expected. Moreover, a reduction in time, labor, and cost for carrying and installing a flat panel display device can be expected by reducing the weight of the flat panel display device. Furthermore, the flat panel display device can be directly installed on a wall or the like. In particular, in the case of a current plasma display device, the proportion of a glass material in the weight of a monitor (image displaying part) is approximately 35%. A reduction in the thickness of a glass substrate allows the above proportion to be reduced as well as allows the weight of the plasma display device to be reduced.

The weight of a glass substrate is reduced by approximately 29% of the current weight by using a thinner glass substrate thickness of 2.0 mm, and is reduced by approximately 46% of the current weight by using a thinner thickness of 1.5 mm, thus allowing for a significantly reduction of the weight of the glass substrate. Therefore, a glass substrate preferably has a thickness of 2.0 mm or less, more preferably 1.5 mm or less.

The glass materials used in the current CRT and PDP have a crack occurrence rate of 100% at an applied load of several tens of grams, while the glass material according to the present invention has a crack occurrence rate of approximately 50% at an applied load of 1000 grams and thus has extremely higher resistance to cracking as compared with the current CRT and PDP. This makes it possible to improve the yield associated with a damage during transportation and during manufacturing process. This is thus effective for cost reduction.

A flat panel display device according to the present invention makes it possible to thin a glass substrate by using a glass material that is less likely to crack. This makes it possible to reduce the weight of a glass material, in turn, the weight of a flat panel display device, and also makes it possible to reduce the transportation cost and increase the degree of freedom in the installation method. On the other hand, if the density of a glass material becomes higher, the effect due to the reduction in the thickness of a glass substrate will be reduced. Therefore, a glass material preferably has a density of 2.7 g/cm³ or less, more preferably 2.6 g/cm³ or less.

Moreover, a shatterproof layer and the like for preventing scattering of glass due to breakage in preparation for possible breakage of a glass substrate may be formed. However, the glass material according to the present invention does not contain Na, which moves most easily among the alkali components, because the inventive glass material has a high electric resistance as described above. For this reason, the inventive glass material is chemically stable, so that even when the above-described shatterproof layer and the like are formed on the surface of the inventive glass material, advantageously separation, performance degradation, and the like of these layers will not easily occur.

As described above, it has been found the glass of the present invention is suitable for a display device as compared with the comparative examples.

A glass material according to the present invention can be made as a glass with a small thickness per piece because of a special toughing mechanism. Therefore, when it is particularly used for applications requiring strength, it is possible to further increase the reliability of a display device by installing a glass material as a front filter on a display surface side, the glass material being formed by laminating one or more sheets of glass via a resin film. However, in the case of the laminated glass the total weight of glass materials increases in proportion to the number of laminated glasses. Therefore, the total thickness of the laminated glass materials is desirably the same as or less than that of a one-piece material so that the laminate does not have excessive weight.

Further, in the case of this laminated glass material, it is possible to further increase strength by placing a wire of metal, ceramics, carbon fibers, glass fibers or the like, in a resin layer when glass lamination is performed.

Furthermore, a wire of metal, ceramics or the like may also be placed in a glass, as a method for placing a wire in the above-described glass material. In this case, a wired glass plate can be made by inserting a wire of heat resistant metal, ceramics or the like while a glass raw material is in a molten state at a high temperature followed by cooling and solidification of the glass raw material. Prevention of falling and scattering of broken glass pieces due to collision of heavy objects can be expected by placing a wire in the above-described transparent glass. This is particularly suitable for a flat panel display device to be installed in the outdoors.

A glass material according to the present invention can be colored by containing various elements. Coloring elements include iron, cobalt, nickel, chromium, manganese, vanadium, selenium, copper, gold, silver, and etc., in addition to rare earth elements. It is possible to improve contrast of a flat panel display device by coloring a glass material by adding a suitable amount of any of these coloring elements depending on applications.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

The present invention described above can eliminate the diffusion prevention layer and thus increase the mass productivity of display devices and reduce the cost. The present invention also can prevent degradation of electron sources and improve reliability of the display device.

1. A flat panel display device comprising at least two substrates and a light emitting part provided between the two substrates, wherein at least one substrate of the two substrates is composed of a glass material containing SiO₂ as a main component and containing 1% to 10% by weight of at least one type selected from the group consisting of La, Y, Gd, Yb, and Lu in terms of oxides, 5% to 25% by weight of R₂O (R denotes one or more types selected from the group consisting of Li, K, Cs, and Rb), and 8% to 20% by weight of Al₂O₃, and wherein a surface electric resistance at 350° C. of the glass material is higher than ×10⁸ (Ω/square).

2. The flat panel display device according to claim 1, wherein the glass contains 15% or less by weight of B₂O₃ and 15% or less by weight of R′O (R′ denotes an alkaline earth metal) in terms of oxides.

3. The flat panel display device according to claim 1, wherein the glass contains 45% to 65% by weight of SiO₂ in terms of oxides.

4. The flat panel display device according to claim 1, wherein the glass material contains a coloring component.

5. The flat panel display device according to claim 1, wherein the light emitting part comprises a plurality of electron sources formed on a back substrate and comprises a fluorescent substance formed on a front substrate, the fluorescent substance being arrayed corresponding to the electron source.

6. The flat panel display device according to claim 1, further comprising a frame glass which holds a gap between the respective substrates and which vacuum seals an interior thereof, wherein the frame glass is fixed to the respective substrates via a sealing material, and wherein the frame glass is composed of a glass which contains SiO₂ as a main component and contains 1% to 10% by weight of at least one type selected from the group consisting of La, Y, Gd, Yb, and Lu in terms of oxides, 5% to 25% by weight of R₂O (R denotes one or more types selected from the group consisting of Li, K, Cs, and Rb), and 8% to 20% by weight of Al₂O₃.

7. The flat panel display device according to claim 1, further comprising a spacer which holds a gap between the respective substrates, wherein the spacer is composed of a glass which contains SiO₂ as a main component and contains 1% to 10% by weight of at least one type selected from the group consisting of La, Y, Gd, Yb, and Lu in terms of oxides, 5% to 25% by weight of R₂O (R denotes one or more types selected from the group consisting of Li, K, Cs, and Rb), and 8% to 20% by weight of Al₂O₃.

8. The flat panel display device according to claim 1, wherein the glass material of the substrates has a shatterproof layer therein.

9. A flat display device comprising a display panel and a filter glass material disposed on a display surface side of the display panel, wherein the display panel comprises two substrates and a light emitting part provided between the two substrates, and wherein the filter glass is a glass material which contains SiO₂ as a main component and contains 1% to 10% by weight of at least one of La, Y, Gd, and Yb in terms of oxides.

10. The flat panel display device according to claim 9, wherein the filter glass is a laminated material formed by laminating two or more sheets of glass material via an adhesive layer.
